(19) United States
(12) Patent Application Publication
(10) Pub. No.: US 2006/0288326 A1
(43) Pub. Date: Dec. 21, 2006

(54) Domain modeling system and method

(75) Inventors: Michelle A. Raymond, Minneapolis, MN (US); Todd P. Carpenter, St. Paul, MN (US); Dal Vernon C. Reising, Minneapolis, MN (US); Christopher A. Miller, St. Paul, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/137,832

(22) Filed: May 25, 2005

(51) Int. Cl. G06F 9/44

(52) U.S. Cl. 717/100

(57) ABSTRACT

A method of domain modeling for use in generating a computer application. The method includes selecting a generic signature for a general domain element type, creating a specific signature for a specific domain element within the domain element type, and saving the specific signature to a memory for use in the computer application. The generic signature including a plurality of attributes. Creating the specific signature includes populating each of the plurality of attributes with a specific attribute datum.

### CROSS-REFERENCE TO RELATED APPLICATIONS

This application is related to Ser. No. XX/XXX,XXX filed concurrently herewith, entitled “Interface Design System and Method with Integrated Usability Considerations” and having the attorney docket number H0003512-0760, which is incorporated by reference herein in its entirety.

### BACKGROUND

The present invention relates to a domain modeling system and method of use. More particularly, the present invention relates to a domain modeling system and method for use with an interface design system that produces adaptable (during run-time) or static (at system commissioning) user interfaces.

Many tools have been created to aid a human in the design of products and/or performance of particular tasks. These tools, however, are not easily adaptable to changing environment as each tool is designed for specific use and specific domains with specific devices in hand. These tools are not flexible. For example, many computer aided design (CAD) systems that aid in the design of integrated circuits do not also aid in the design of automobile engines. In addition, these tools only provide a limited capability at the most of designing an interface between the product or system being designed and an end user of that product or system. Otherwise stated, conventional systems for design typically allow a designer to design a particular user interface or series of user interfaces for use in a single domain, a single group of tasks, a single set of delivery devices that can be used by the user to access the system, and particular roles of the users within the system, but not for all simultaneously.

Typically, generation of user interfaces for various programs, activities, and tasks is completed by selecting individual templates for performing each task or sub-task and subsequently manually linking each template together on an individualized basis. As such, conventional systems that assist in user interface generation are designed to aid the designer in generation of single interfaces for a given domain or task, but do not typically assist in the linkage of and/or arranging the multiple task-based interfaces together.

In such systems, entire domains are typically defined in a hierarchy from element types to specific instances of those types. However, other than the general types of attributes and relationships defined in element types, little is provided to help interface designers to quickly and effectively define abstract objects within the overall domain. With at least the above reasoning in mind, a user interface generation system is desired that additionally assists a designer in modeling domain objects.

### SUMMARY

One aspect of the present invention relates to a method of domain modeling for use in generating a computer application. The method includes selecting a generic signature for a general domain element type, creating a specific signature for a specific domain element within the domain element type, and saving the specific signature to a memory for use in the computer application. The generic signature includes a plurality of attributes. Creating the specific signature includes populating each of the plurality of attributes with a specific attribute datum.

Another aspect of the present invention relates to an application design method includes providing a signature template for each of a plurality of domain element types, selecting the signature template for one of the plurality of domain element types, generating a specific signature for a domain element within the one of the plurality of domain element types, and comparing the specific signature to the signature template to recognize the domain element as being categorized as one of the plurality of domain elements types. The signature template includes a plurality of general attributes. The specific signature is generated from the signature template by converting the plurality of general attributes into a plurality of specific attributes; and

Yet another aspect of the present invention relates to a computer-readable medium having computer-executable instructions for performing a method of generating an application, either as a single execution at commissioning or as a continuous execution in real-time. The method of generating an application includes providing a signature template for each of a plurality of domain element types, selecting the signature template for one of the plurality of domain element types, and converting the selected signature template into a specific signature for a domain element within one of the plurality of domain element types. The signature template includes a plurality of general attributes. Converting the selected signature template includes populating each of the plurality of general attributes with a specific attribute datum. The specific signature is formatted for use within an application being designed due to a portion of the plurality of general attributes of the selected signature template incorporated into the specific signature during conversion of the selected signature template.

### BRIEF DESCRIPTION OF THE DRAWINGS

FIG. 1 is a block diagram illustrating a computer system useful in implementing a user interface system according to one embodiment of the present invention;

FIG. 2 is a block diagram illustrating the general architecture of the user interface generation system according to an embodiment of the present invention;

FIG. 3 is a organizational diagram illustrating one embodiment of a domain modeling hierarchy used to provide the inputs of FIG. 2;

FIG. 4 is an organizational diagram illustrating one embodiment of a general signature according to one embodiment of the present invention;

FIG. 6 is a flow chart illustrating one embodiment of a domain element modeling process according to the present invention; and

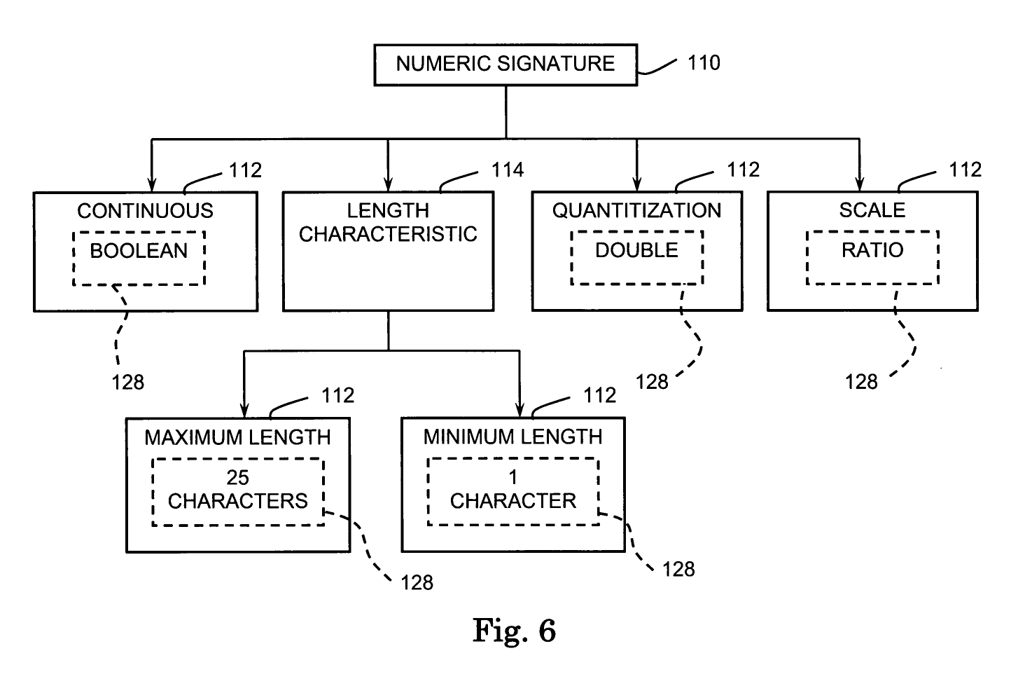

FIG. 5 is an organizational diagram illustrating an example numeric signature for use in the domain modeling process of FIG. 6.

### DETAILED DESCRIPTION

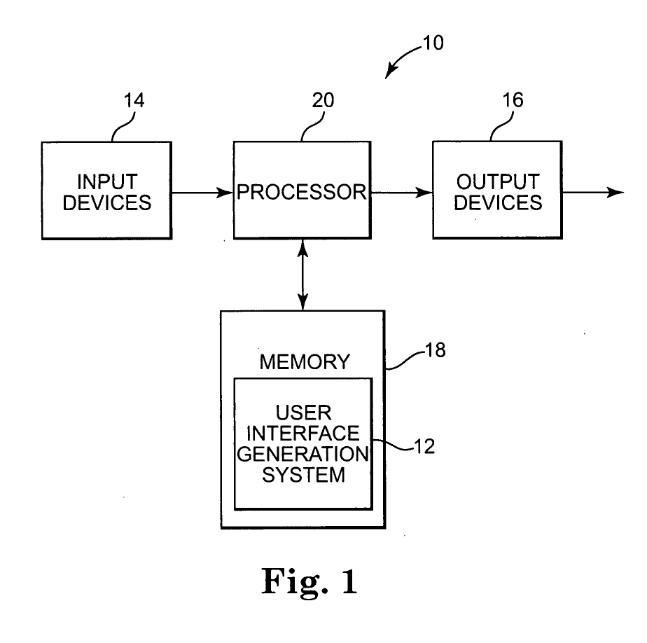

One embodiment of a computer 10 for implementing a user interface generation system 12 is generally illustrated in FIG. 1. The computer 10 includes one or more input devices 14, one or more output devices 16, a memory 18, and a processor 20. Input and output devices 14 and 16 allow a designer to interact with the processor 20 as well as the user interface generation system 12 for the development and generation of user centered user interfaces. In particular, the user interface generation system 12 interacts with the designer to generate end presentations that have been evaluated with usability criteria.

In one embodiment, the one or more input devices 14 include devices such as a keyboard, a mouse, and/or a modem that can be accessed by the designer to provide various input to the interaction design system 12 to design and generate user interfaces. For example, the designer can use a keyboard of input devices 14 to provide task, user, domain, or other information to user interface generation system 12. In another example, task, domain, and/or user information is generated remotely and provided to the design system 12 via a modem of input devices 14. In addition, input devices 14 may include a drive for receiving one or more of various types of memory storing information previously generated by the designer. Notably, the designer as used herein refers to any user of the user interface generation system 12 that is generating or assisting in the generation of a user interface. Accordingly, the designer refers to the initial designer as well as any middle designer modifying or further customizing a user interface for a particular domain, task, user, etc.

In one embodiment, output device 16 includes one of a printer, a display for presenting visual, audio, and/or other output, and a modem facilitating designer interaction with the interaction design system 12 on computer 10. Notably, a single modem may be used as one of the input devices 14 and the output devices 16.

Memory 18 includes volatile memory (e.g. random access memory (RAM)) and/or non-volatile memory (e.g. a hard disk drive or other persistent storage device). The memory 18 stores the user interface generation system 12 that is executed by the computer 10 to design and generate user interfaces, and may be used and accessed by the user interface generation system 12 during execution. In one embodiment, the memory 18 is further used to store various inputs that may be created by the designer and that are used by the user interface generation system 12 to generate user interfaces. In one embodiment, the various inputs are stored within the memory 18 in the form of models and libraries that can be reused in subsequent generation of additional user interfaces.

The processor 20 is electronically coupled with input devices 14, output devices 16, and memory 18. In one embodiment, the processor 20 includes hardware, software, firmware, or a combination of these. In one embodiment, the processor 20 includes a computer server or other microprocessor based system capable of performing a sequence of logic operations. Communications with the end user via input devices 14 and output devices 16 are sent via the processor 20. In addition, the processor 20 accesses the memory 18 during functioning to define or complete various tasks as asked of the processor 20. In one embodiment, the processor 20 is coupled with the memory 18 via the internet or a server system.

Notably, components of the present invention can be implemented in hardware via a microprocessor, programmable logic, or state machine, in firmware or in software with the given device. In one aspect, at least a portion of the software programming is web-based and written in Hyper Text Mark-up Language (HTML) and/or Java programming languages, including links to interfaces for data collection, such as a Windows based operating system. Each of the main components may communicate via a network using a communication bus protocol. For example, the present invention may use a Transmission Control Protocol/Internet Protocol (TCP/IP) suite for data transport. Other programming languages and communication bus protocols suitable for use with the present invention will become apparent to those skilled in the art after reading this disclosure. Components of the present invention may also reside in software on one or more computer-readable mediums. The term “computer-readable medium,” as used herein, is defined to include any kind of memory, whether volatile or non-volatile, such as floppy disk, hard disk, CD-ROMs, flash memory, read-only memory (ROM) and random access memory (RAM). The term “computer-readable medium” is also used to represent carrier waves on which the software is transmitted.

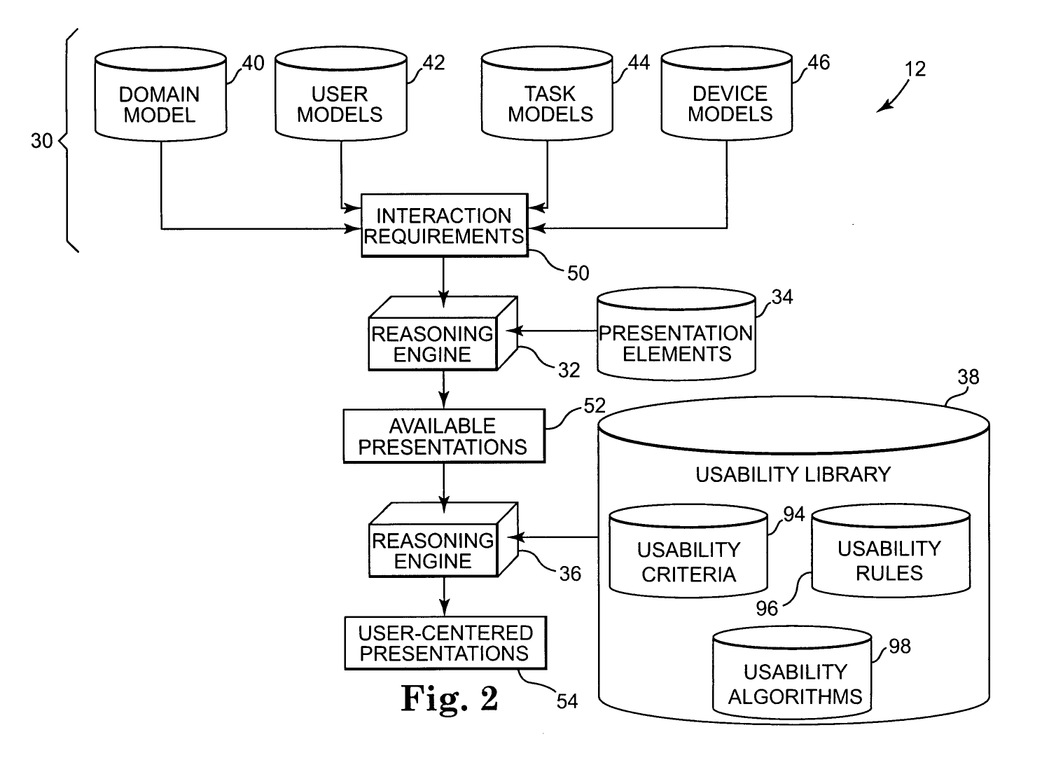

FIG. 2 illustrates the general architecture of the user interface generation system 12. The user interface generation system 12 includes various inputs 30, a reasoning engine 32, presentation elements 34, a reasoning engine 36, and usability library 38. The various inputs 30 include a domain model 40, user models 42, task models 44, and device models 46. Generally speaking, the inputs combine to define an interaction requirement 50 defining the necessary attributes and functioning of a specific application being designed. Based at least in part upon the interaction requirement 50 and presentation elements 34, the reasoning engine 32 presents available presentations 52 meeting the interaction requirement 50. At least a portion of the available presentations 52 are forwarded to the reasoning engine 36 for analysis for various usability considerations stored in usability library 38 to result in one or more user-centered presentations 54 as will be described in further detail below.

More specifically, the domain model 40 is a machine interpretable domain-specific representation of the relevant domain attributes to be given to a user interface. These attributes include the data, information, concepts, and/or relations pertinent to the application and domain for which the user interface is being designed.

The user model 42 defines the preferences, roles, abilities, and limitations, if any, of the users who are identified by the designer as the potential users within the domain of the user interface being designed. The preferences, roles, and abilities of the users in one embodiment include individualized role descriptions, delivery device preferences, modality, such as visual or audible preferences, physical challenges that may confront the users of the user interface being designed, etc. With this in mind the designer can best develop a user centered interface by understanding the capabilities and preferences of the user and the application requirements and using that understanding to create the user models 42 to define the relationship between the users and the application and the particular preferences of the user as they deal with the application.

The task models 44 represent the actions to be performed by the users accessing the user interfaces, the goals to be achieved by the user when using the user interface, and the information required to perform such actions and to achieve such goals. In this manner, the task models 44 capture what actions on the part of the user the interfaces are intended to afford or support. In modeling a particular task, the designer decomposes each task or interaction to be performed into a sub-task, if any, which is then transformed into task primitives or basic tasks, an order of flow from each task primitive, and the type of information required by each task primitive.

For example, in one embodiment, task primitives include at least one of the following: receive, instantiate, compare, monitor, assert, select, control, retract, change, detect, direct attention, navigate, adjust, and any synonyms of the above task primitives, etc. Notably, each task primitive is expressed from the perspective of the end user. In particular, “receive” is used to describe the user's receipt of information rather than “sent,” which would be described from the computer's perspective. Systems can also be developed from the data flow or process-centric view. However, in one embodiment, the user-centric approach described herein lends itself to easier applicability of usability scoring.

The order of flow refers to the precedence or chronological order between multiple task primitives as can be designated and expressed by junctions and links in the notation applied to the task model 44. For example, such junctions include AND, OR and XOR junctions that may be synchronous or asynchronous. Links, for example, indicate that action B does not start before action A completes, that action A must be followed by action B, that action B must be preceded by action A, that actions A and B are both required, etc.

In addition, the task models 44 also include the information required by the task primitives of the task being modeled. For example, the task primitive “receive” requires that information is to be received by the user. Accordingly, the designer defines the specified type of information that is needed for the task primitive in the particular task model 44. In one embodiment, the task models 44 include multiple task models that have been previously modeled and that can be later selected for subsequent interface generation and/or task modeling. In other embodiments, partial task models exist for use as templates for quickly forming similar task models.

A device model 46 is defined for each possible device available for use with the particular application being modeled. Rather than merely listing the device name, each device model 46 specifies a particular device based upon the capabilities and modalities of the delivery device available to the end user to execute the interface and relevant to the application. In one embodiment, the capabilities include at least one of available bandwidth, memory, screen size, lines of display, width of display, illumination, etc., and the modalities include visual, audible, etc. In one embodiment, the specifications and characteristics are captured using flexible notation such as RDF.

In one embodiment, modalities and capabilities for the particular device are described with respect to input modalities and capabilities and output modalities and capabilities. The modular nature of the device models 46 allows new technology devices to be easily incorporated into existing systems as will be further described below. In particular, new devices are added by describing the device capabilities and modalities. This ability allows the user interface generation system 12 to adapt to impending advancements in the technological field of electronic devices. In one embodiment, modeled devices include web browsers, personal digital assistants (PDA), telephonic interaction delivery devices, personal computers, cell phones, analog phones, etc. The domain model 40, the user models 42, the task models 44, and the device models 46 are each stored in the memory 18 in preparation for the execution of the user interface generation system 12.

In one embodiment, at least a portion of the inputs 30 is entered using signatures. A signature is an organized manner of presenting abstracted attributes of a domain element. The signatures are part of the user interface generation system 12 and, therefore, are stored in memory 18.

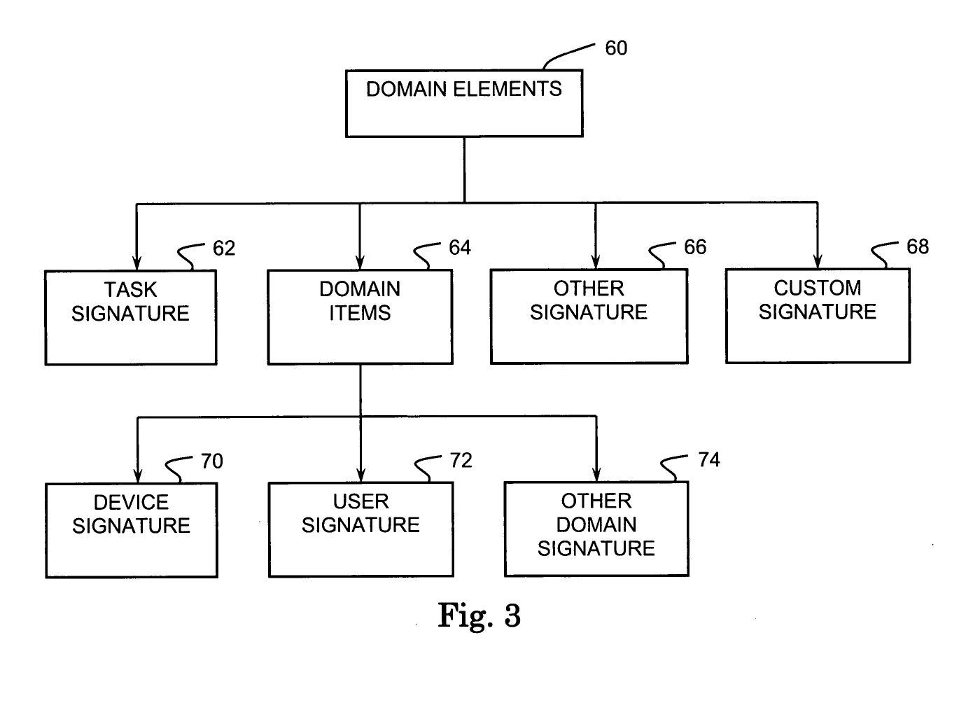

As illustrated in FIG. 3, much of input 30 can be broken down into domain elements 60. A domain element 60 is a representation of anything in the domain, including tasks, interaction devices, domain items, and other signature described objects or nouns. In one embodiment, the representations of the domain elements 60 include at least one of a task signature 62, domain items 64, template signatures 66, and custom signatures 68. The domain items 64 are a subset of the domain elements 60 that relate directly back to the domain model 40. As such, the domain items 64 are indirectly also considered domain elements. The domain items 64 include representative components such as device signatures 70, user signatures 72, and other signatures 74 related to the domain model. Accordingly, all such elements within a domain are represented within the user interface system 12 with signatures. In one embodiment, the template and other signatures 66 and 68 are used to model all nouns to be part of the system including text, graphics, temporal, enumerations, names, etc.

More specifically, by defining each domain element 60 with a signature, each domain element is modularly defined, thereby, making editing of and creation of the domain element definitions or signatures more efficient for the designer. The number of signatures necessary is end application specific. In one embodiment, zero or more of each of the signature types 62, 66, 68, 70, 72, and 74 are modeled by the designer.

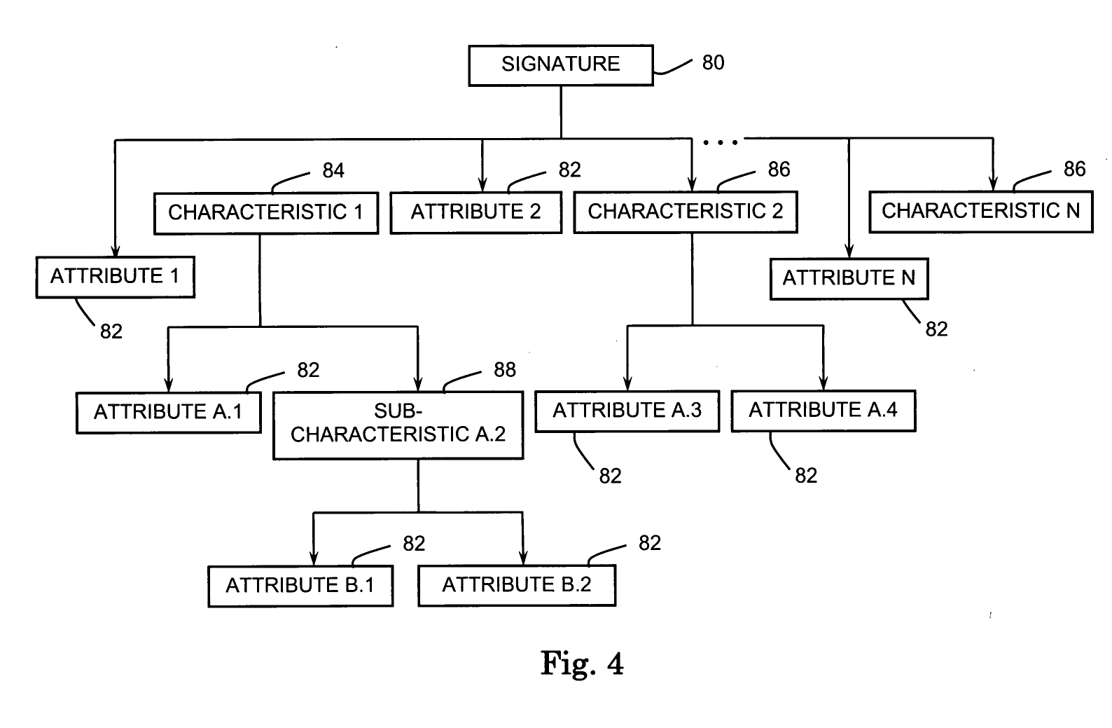

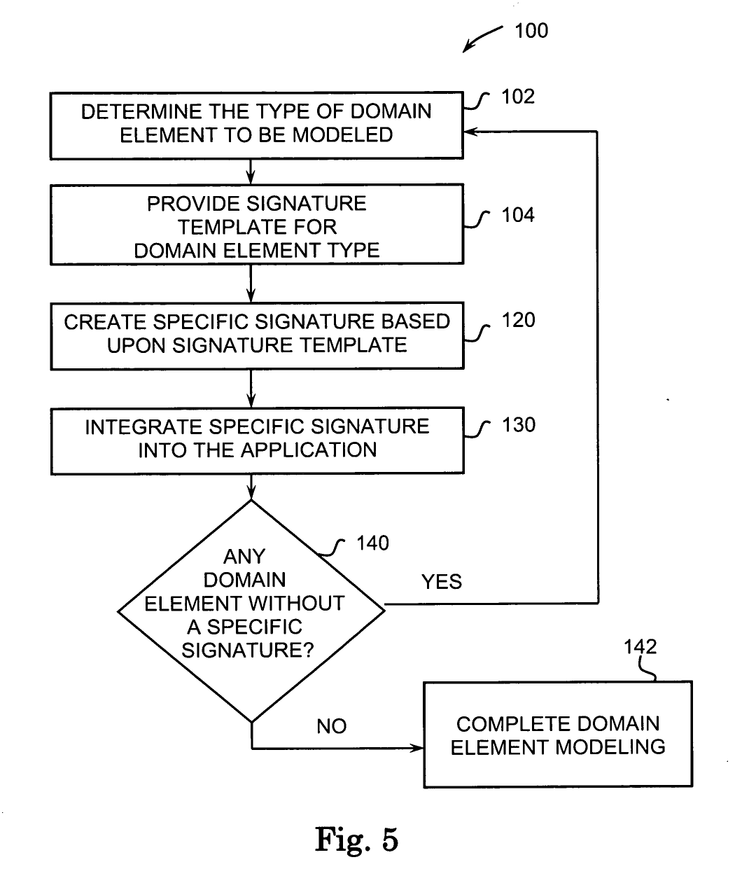

One generalized example of a signature 80 is illustrated in FIG. 4. Each signature 80 includes at least one and preferably a plurality of attributes 82. Each attribute 82 at least partially describes the domain element 60 being represented by the signature. For example, if the element is a text element, one attribute 82 is a minimum number of characters to be included in the text element, a second attribute is a maximum number of characters to be included in the text element, etc. Generally, if the signature 80 is for a domain item the attributes relate to the qualities and capabilities of the domain item. If the signature 80 is for a task, the attributes generally relate to task primitives, order of flow, and necessary information. If the signature 80 is for a presentation element, the attributes generally relate to the requirements to display (i.e., present or output) the presentation element. Finally, if the signature 80 is for a device, the attributes generally relate to the capabilities of the device.

In one embodiment, in which the signature 80 includes a plurality of attributes 82, at least a portion of the attributes may be grouped into one or more characteristics 84 and 86. Each characteristic 84 and 86 represents a generalized cluster of attributes all having a common general relationship or use. In one embodiment, the characteristics 84 and 86 are specifically chosen to group attributes 82 for later use within the application being deigned. By grouping a portion of attributes 82 together into usage characteristics, the amount of attributes 82 that need to be parsed when the application is run is decreased, thereby, increasing overall speed of the end application.

For example, a device signature may include an audible characteristic 84 including attributes of the device relating to the audible abilities of the device and a graphical characteristic 86 including attributes of the device relating to the graphical abilities of the device. In this case, a task for providing graphical output only looks to attributes of the graphical characteristic and ignores attributes of the visual characteristics. Use of one or more sub-characteristics 88 can further refine this categorization, wherein each sub-characteristic 88 includes at least one attribute 82. Since all attributes do not need to be parsed to complete the task, the task is generally completed more quickly than in applications without modular signature definition of domain elements in which all attributes are parsed. In other embodiments, at least one of the characteristics is divided into zero or more sub-characteristics 88 wherein each sub-characteristic 88 includes at least one attribute 82. Accordingly, in one embodiment, the attributes 82 within the signature 80 are at least partially categorized for future processing. With this in mind the number of attributes 82, characteristics 86 and 88, and sub-characteristics 88 are dependent upon the complexity of signature 80 and how many attributes 82, characteristics 86 and 88, and sub-characteristics are used to develop the signature 80.

A plurality of signatures similar to signature 80, namely task signatures 62, device signatures 70, user signatures 72, and other domain signatures 74 illustrated in FIG. 3 that have a general structure similar to that described with respect to signature 80, are used to define each of the domain elements 60. In one embodiment, each signature type 62, 70, and 72 includes a signature template or generic template generally modeling a few basic attributes and or characteristics that will be included in any specific signatures generated for each of the respective tasks, devices, or users. As used herein, “generic” relates to signatures or attributes sufficiently broad to cover a plurality of domain elements, wherein “specific” refers to signatures or attributes customized to define a particular domain element.

For instance, one example of a general user signature template includes general attributes, such as name, access level, device preferences, etc. However, the signature templates do not generally define what the name, access level, device preference, etc. is, but merely that such an attribute will be present in the finalized signature. In order to convert any of the signature templates into a working signature the values or specifics of each attribute is specifically defined.

Similar templates exist within memory 18 for other predefined domain element signatures 66. The predefined signature templates 66 are defined for modeled nouns such as text, unit of measurement, numeric, enumerations, lists, etc. In one embodiment, predefined signatures 66 additionally exist for modeling individual presentation elements 34. In particular the general attributes that will be included within a signature for one of the above nouns are already listed in the corresponding signature template. In addition, in one embodiment, a designer can create custom element signatures 68 that are relatively more application specific than the predefined templates. Therefore, if an element to be modeled is not conducive to use with existing signature templates, a new signature and or template is developed by the designer as a basis for creating working signatures for each of these elements. The custom element signatures 66 can be defined for task signatures, device signatures, user signatures, and/or other type signatures.

For instance, FIG. 5 illustrates a flow chart for a domain modeling process generally at 100. At 102, the designer determines the type of domain element to be modeled. More specifically, the designer determines if the domain element being modeled is a task, user, device, number, etc. For purposes of this example, at 102, it is decided that the domain element being modeled is a numeric object.

Then at 104, a signature template is provided matching the type of domain element as determined at 102. In one embodiment, the signature template is predefined and is accessed from memory 18. In other embodiments, the predefined signature templates are not suitable for use either the domain element being modeled, and the designer must create a new or customer signature template. Accordingly, the designer breaks down the type of domain element into a plurality of general attributes common to the domain element type and, optionally, groups a portion of the attributes into characteristics and sub-characteristics.

In the case of this example, a numeric signature template exists within the memory 18. One embodiment of a numeric signature template is generally illustrated at 110 with additional reference to FIG. 6. In this example, the numeric signature template 110 includes continuous, maximum characters, minimum characters, quantitization, and scale general attributes 112. In one embodiment maximum and minimum character attributes 112 are grouped into a length characteristic 114.

At 120, a specific domain element signature is created based upon or converted from the signature template 110. More particularly, the designer accesses the numeric signature template 110 and enters the specific values, descriptions, or datum 122, which are generally indicated with broken lines, to convert the each general attribute into a specifically described attribute. The specific values 122 specifically define the attribute rather than generally indicating that an attribute type exists. Once the attributes are all specifically described, as necessary, the signature template is similarly converted into a working or specific numeric signature for use in the application being designed.

In one embodiment, the designer adds new attributes to or removes general attributes from those initially included in the signature template 110. Other signature templates are similar to numeric signature template 110, but are geared toward the particular object or noun being represented. In one example, the designer additionally groups or sorts the attributes to define new or reorganize old characteristics and sub-characteristics. Further, the signature templates will vary in complexity and size due to the object being modeled and the end use or uses of the object in a particular application.

At 130, the now specific numeric signature is updated, if necessary to integrate the specific signature into the application. In one embodiment, due to the format of the signature template and since the specific template is based on the signature template, the specific template automatically includes any data or information necessary to be readily incorporated into the application being designed. At 140, it is decided whether any additionally domain elements require signatures to be produced. If yes, steps 102, 104, 120, 130, and 140 are repeated for the new domain element. If no, at 142 domain modeling is completed. It should be noted, that all domain modeling does not need to be completed at one step in the overall design process. Rather, signatures can be periodically created for various domain elements as necessary, even after the application is primarily completed.

By modularly defining each domain element within models 40, 42, 44, and 46 with signatures, each element can be accessed within the application on a micro level based upon the individual attributes of concern to the application. For example, in one embodiment user domain element of a doctor is described with a user signature including attributes relating to name, degree, specialty, patient list, schedule, appointment duration, etc. In an application task that finds a doctor's name based upon a given patient name, the application need not parse through attributes relating to degrees, specialties, schedule, appointment duration, etc. Rather, to complete the task only the attributes relating to the doctor's name and the patient list need to be accessed. The use of characteristics further facilitates the categorization of attributes to further aid the designer is selecting attributes relevant to a given task. Use of sub-characteristics can further refine this categorization. Since all attributes do not need to be parsed to complete a task, the task is generally completed more quickly than in application without modular signature definition of domain elements.

Moreover, the modular signature also allows new devices that may not have been in existence at the time an application was originally written to be incorporated within the application. This is accomplished since each device is defined by individual capability attributes, such as screen capacity, transmission speed, audio capabilities, available memory, data format, etc. rather than simply being describes as a device designation, such as a PDA, etc. Accordingly, the application is designed to work with each device on the basis of the device attributes rather than the overall device designation. Since the application is already centered around the attributes, it can incorporate new devices by analyzing the attributes of the new device rather than dealing with a new device designation. For example, an application attempting to output text information can work with any device capable of supporting a textual display and of receiving data in an available format.

Referring once again to FIG. 2, once modeled, each of the domain model 40, the user models 42, the task models 44, and the device models 46 combine to define interaction requirements 90 of the user interface being designed. Each interaction requirement 90 is a combination of a task primitive and information required by the task primitive as influenced by the characteristics of the users and the application and domain for which the user interface is being designed. Accordingly, the interaction requirement 90 is dependent at least to some extent upon the specific attributes included in the various signatures of the domain model 40, the user models 42, the task models 44, and the device models 46. Therefore, a user interface typically involves a plurality of interaction requirements 90 that define the totality of the way in which the user is expected to interact with the user interface being designed.

The reasoning engine 32 of the interaction design system 12 is configured to make qualitative judgments about the presentation elements available to support the performance of the various interactions required of the user interface being designed and the input and output of the information required by the interaction requirements 90. In one embodiment, the reasoning engine 32 is defined as part of the processor 20 (FIG. 1) of computer 10. In particular, the reasoning engine 32 is configured to match available presentation elements with the interaction requirements 90 to define available user interfaces that best perform the interactions as required by the user.

The available presentation elements are stored in the presentation elements library 34. A presentation element corresponds to specific presentation methods and defining the attributes or characteristics devices must possess to be capable of supporting the presentation method. In one embodiment, each presentation element also specifies the type of task primitive and the type of associated information the presentation method is designed to support. Otherwise stated, the presentation elements are the display objects that are used to present information to or to acquire information from a user of the user interface being designed. In one embodiment, the presentation elements are each defined within system 12 with a signature similar to the signatures described above. In the context of a web browser being used as the delivery device, a presentation element can include a pop-up menu, a pull down menu, a plain text element, a dialog box, a button, etc. Notably, as used herein, the term “display” refers to any output presentation, including one or more of a visual component, an audio component, and/or other mode components.

Accordingly, each of the presentation elements stored in the presentation elements library 34 contains a set of functionality and usability characteristics that the corresponding presentation element either supports or requires for correct application within a user interface presentation. The functionality and usability characteristics describe the quality of the interaction that can be achieved given the functionality and usability characteristics of the display objects. The functionality and usability characteristics for each presentation element should have a form so that they can be matched by the reasoning engine 32 to other inputs, more specifically, to other input signatures, and so that the reasoning engine 32 can make qualitative judgments about the ability of the presentation elements to support the input and output of the data to be exchanged between the users and the user interfaces. For example, within a particular task, the presentation element of a pull down menu may be well suited to a task of selecting from a group of items, but may not be well suited for use in inputting information not selected from a previously defined group or information unit. Accordingly, when the reasoning engine 32 considers the interaction requirements, it considers what needs to be completed by who and on what device by the user interface being designed.

Subsequently, the reasoning engine 32 accesses the presentation elements within the presentation library 34 to decide which presentation elements are available that can perform the necessary interaction requirements 90. As such, the reasoning engine 32 outputs available user interface presentations 92 which meet the interaction requirements. Notably, each presentation is a combination of an available device and the presentation elements to be displayed on the device. As such, the reasoning engine 32 not only defines which of the presentation elements 92 are available to perform the interaction requirements 90, but rather defines which combination of presentation elements and available devices is available to perform the interaction requirements 90.

In one embodiment, the reasoning engine 32 further scores each of the available presentations 92 to define which of the available presentations 92 best meets the interaction requirements 90. In one embodiment, the reasoning engine 32 only presents the designer with the available presentations 92 having the best or better scores than a certain percentage of other available user interface presentations. By scoring the available presentations 92 and only presenting a certain percentage or amount of those presentations, fewer available presentations 92 are presented to the designer for further evaluation, and therefore, the overall speed of evaluation of the available presentations 92 is increased.

The available presentations 92 presented by the reasoning engine 32 continue to the reasoning engine 36. The reasoning engine 36 is configured to perform qualitative judgments regarding the available presentations 92 and their ability to meet general non-task specific usability criteria as well as usability rules customized for the particular application being designed. In one embodiment, the reasoning engine 36 is part of the processor 20 of the computer 10 (FIG. 1). In one embodiment, the reasoning engine 32 and the reasoning engine 36 are each part of a single reasoning engine and are shown as separate reasoning engines 32 and 36 for illustrative purposes only.

In order to determine which of the available presentations 92 are user preferred, the reasoning engine 36 accesses the usability library 38. The usability library 38 includes usability criteria 94, usability rules 96, and usability or user-centered algorithms 98 defining how to collectively compare and analyze those criteria. In one embodiment, the usability criteria 94 includes criteria or parameters for analysis including at least one of display scope, display resolution, display bandwidth, display importance, display obtrusiveness, control scope, control resolution, control bandwidth, control importance, visibility, transmission speed, and/or modality type. Each of the usability criteria 94 stored within the usability library 38 additionally includes a definition of how to score that particular criteria. The usability criteria 94 are selected based upon usability psychology, which is an area of cognitive psychology.

For example, in one embodiment, the usability criteria of visibility is scored on a scale of 1-10 by determining the percentage of the total available options displayed at one time. For example, if there are five options for a user to select from and a pull down menu only shows four of the five without scrolling, the user would see four of the five selections at one particular time. Therefore, 4/5 or 80% of the selections are shown at a single moment in time resulting in an overall visibility score of 8 (80% of 10) on a scale of 1-10. Similar processes are completed for each of the usability criteria ranking each of the criteria on a scale of 1-10. Notably, although described as ranking criteria on a scale of 1-10, usability criteria can be ranked on a variety of scales such as −1 to 1, 0 to 5, etc.

Following ranking of each of the criteria on a predefined scale, such as from 1 to 10, the criteria rankings are plugged into a user-centered algorithm selected from the usability algorithms 98 for determining a collective usability score based on which criteria are most important to the end user within a particular domain. In one embodiment, the user-centered algorithm is modular and can be defined specifically by the designer for particular situations. In one embodiment, the user-centered algorithm provides a weighted average method of determining the overall score.

In one embodiment, the user-centered algorithm includes references to or inclusion of one or more of the plurality of usability rules 96 stored in usability library 38. With this in mind, the user-centered algorithm can include if/then/else statements (such as if a user is a particular type, then apply a particular rule), enumerations, and other references. The usability rules 96 commonly refer to the characteristics and or attributes included in the signatures 80 for users, task, devices, etc. For example, an particular algorithm includes the statement that if the user fits within a definition of an elderly user, then apply any usability rules classified as general elderly rules. The elderly rules may adjust the usability criteria score to raise the score of presentations with larger or easier to read displays, with linear information displays, or with other attributes generally thought to be beneficial to elderly users. Therefore, particular attributes of the user signature are evaluated to determine if the user fits within the rule definition of an elderly user. Once the rules called out in the algorithm are applied, the results of the rules are plugged into the algorithm to derive a final collective usability score.

As such, each of the usability criteria is given a particular weight dependent upon the particulars of the algorithm and/or any rules that may apply to the algorithm. In particular, in one embodiment, after applying any specified rules, the transmission speed may be considered to be more important than overall visibility and, therefore, the transmission speed would be even a higher weight than the visibility within that particular user-centered algorithm. The final product of the user-centered algorithm provides the final collective score within the range of 1-10 that can be easily compared to the final collective scores of presentations produced by the user-centered algorithm.

In one embodiment, in determining which of the user-centered algorithms or usability rules the reasoning engine 36 should utilize to determine the collective score of each presentation, the reasoning engine 36 utilizes specific information from signature for the user model 42. In particular, if the signature for the user model 42 shows a particular user to be deaf, the algorithm or rule may be designed to highly weight visibility scores while lowly weighting or zeroing out scores related to audible communication or audible modalities. Accordingly, presentations receiving the highest or best overall usability scores would be directly related to textural or visual communication versus audible communication to better serve the needs of the deaf user.

In other examples, the signature of the user model 42 defines other particular preferences of the user, such as to receive messages via certain modalities at certain times, by certain modalities when the user is at certain places, etc. Accordingly, the algorithms and rules can be defined to facilitate these user preferences. As such, each possible presentation is evaluated to determine the collective usability score and compared to decide which available presentations are best suited to a particular user or user group. Accordingly, the reasoning engine 36 reports the preferred user interface presentations 52 based upon their ranked collective usability scores. In particular, in one embodiment, the reasoning engine 36 submits only a portion, such as 1, 3, etc., of the preferred user presentations 52 as chosen from the presentations with the highest collective usability scores.

In one embodiment, the algorithm is generally a root mean squared algorithm. Notably, although predefined algorithms and usability rules may be included in the usability library 38 prior to use by a designer, the designer can also create new algorithms and usability rules for use and storage within the usability library 38. Accordingly, the designer can particularly choose which criteria are most important in certain situations and weigh them accordingly. In one embodiment, the designer can write the algorithm in an XML format rather than in a coded format. Accordingly, it is easier for a designer to define the algorithm for subsequent use. In addition, by allowing the designer to have some control over the available algorithms and the rules and criteria incorporated in each particular algorithm, different algorithms can be provided for different tasks, different user groups, etc. to provide a modular system allowing for increased flexibility in the design of the overall user interface being generated. In addition, not only the initial generator of a user interface may have access to providing these algorithms, but also middle users within particular user systems of the developed user interface may also have access to define the usability criteria algorithms and to change them without need to be well-versed in the aspects of code writing.

A user interface generation system according to the present invention is a domain-independent and modular framework for developing user interfaces. The modular nature of providing input to the user interface generation system provides flexibility in creating a user interface that permits complete customization of the interface for a particular domain, task, device, and/or user(s). In addition, use of the modular signature within the overall signature facilitates faster input of data connectivity between domain elements and allows for future adaptively of the user interface for new domain elements, such as new devices, etc. As a result, the user interface generation system aids a designer in relatively quickly creating a particular user interface domain. Moreover, the attributes provided in the input signatures also provide valuable information broken down for use that can be analyzed in view of usability criteria, rules, and algorithms to provide an end user interface tailored to best meet the needs of its probable users and to provide for increased system usability without the need for separate usability studies and multiple revisions of a user interface after its initial completion to achieve a desired usability standard.

Although specific embodiments have been illustrated and described herein it will be appreciated by those of ordinary skill in the art that a wide variety of alternate and/or equivalent implementations calculated to achieve the same purposes may be substituted for the specific embodiments shown and described without departing from the scope of the present invention. Those with skill in cognitive psychology and computer arts will readily appreciate that the present invention may be implemented in a very wide variety of embodiments. This application is intended to cover any adaptations or variations of the embodiments discussed herein. Therefore it is manifestly intended that this invention be limited only by the claims and the equivalence thereof.

What is claimed is:

1. A method of domain modeling for use in generating a computer application, the method comprising:
selecting a generic signature for a general domain element type, the generic signature including a plurality of attributes; and
creating a specific signature for a specific domain element within the domain element type by populating each of the plurality of attributes with a specific attribute datum; and
saving the specific signature to a memory for use in the computer application.

2. The method of claim 1, wherein the domain element is a domain item and the plurality of attributes relate to the qualities and capabilities of the domain item.

3. The method of claim 1, wherein the domain element is a task and the plurality of attributes relate to a designation of at least one task primitive.

4. The method of claim 1, wherein the domain element is a presentation element, and the plurality of attributes relate to the requirements to display the presentation element.

5. The method of claim 1, wherein the domain element is a device, and a portion the plurality of attributes relate to any capabilities of the device.

6. The method of claim 1, wherein selecting the generic signature includes choosing the generic signature from a plurality of predefined generic signatures, and further wherein each of the plurality of predefined generic signatures relates to a different general domain element type.

7. The method of claim 1, wherein the specific signature is a first specific signature, and the specific attribute datum is a first specific attribute datum, the method further comprising:
creating a second specific signature for a specific domain element within the domain element type by populating each of the plurality of attributes of the generic signature with a second specific attribute datum.

8. The method of claim 1, wherein selecting a generic signature includes creating the generic signature by defining the plurality of attributes for the generic signature.

9. The method of claim 1, wherein selecting the generic signature, creating the specific signature, and saving the specific signature is completed for a plurality of general domain element types to collectively define a specific domain.

10. The method of claim 1, wherein the generic signature includes at least a portion of the plurality of attributes being grouped into at least one characteristic.

11. The method of claim 1, wherein creating the specific signature includes grouping a portion of the plurality of attributes each populated with the specific attribute datum into at least one characteristic.

12. The method of claim 11, wherein grouping the portion of the plurality of attributes includes grouping a fraction of the portion of the plurality of attributes as a sub-characteristic.

13. An application design method comprising:
providing a signature template for each of a plurality of domain element types, wherein the signature template includes a plurality of general attributes;
selecting the signature template for one of the plurality of domain element types;
generating a specific signature for a domain element within the one of the plurality of domain element types, wherein the specific signature is generated from the signature template by converting the plurality of general attributes into a plurality of specific attributes; and
comparing the specific signature to the signature template to recognize the domain element as being categorized as one of the plurality of domain elements types.

14. The method of claim 13, wherein the domain element is one of a task, a user, and a device.

15. The method of claim 13, wherein selecting the signature template includes choosing the signature template from a plurality of signature templates, and further wherein each of the plurality of signature templates relates to a different domain element type.

16. The method of claim 13, wherein selecting the signature template and generating the specific signature is completed for a plurality of general domain element types to collectively define a specific domain.

17. The method of claim 13, wherein selecting a signature template includes creating the signature template by defining the plurality of attributes for the signature template.

18. The method of claim 13, further comprising:
generating a user interface based at least in part upon usability considerations, including referencing the specific signature to determine at least one of a user preference and a user ability.

19. The method of claim 13, further comprising:
designing the application to complete a task related to the specific signature by accessing a fraction of the plurality of specific attributes.

20. The method of claim 19, wherein designing the application includes identifying a characteristic related to the tasks, and the fraction of the plurality of specific attributes is the plurality of specific attributes grouped into the characteristic.

21. A computer-readable medium having computer-executable instructions for performing a method of generating an application either as a single execution at commissioning or as a continuous execution in real-time comprising:
providing a signature template for each of a plurality of domain element types, wherein the signature template includes a plurality of general attributes;
selecting the signature template for one of the plurality of domain element types;
converting the selected signature template into a specific signature for a domain element within one of the plurality of domain element types, wherein converting the selected signature template includes populating each of the plurality of general attributes with a specific attribute datum; and
wherein the specific signature is formatted for use within an application being designed due to a portion of the plurality of general attributes of the selected signature template incorporated into the specific signature during conversion of the selected signature template.

22. The computer-readable medium having computer-executable instructions for performing the method of claim 21,
generating available user interface presentations;
selecting one of the available user interface presentation based upon an output of at least one usability rule, wherein the output varies based upon at least one of the specific attribute datum of the specific signature.

23. The computer-readable medium having computer-executable instructions for performing the method of claim 22, wherein the domain element is a user.

24. The computer-readable medium having computer-executable instructions for performing the method of claim 23, wherein the at least one of the specific attribute datum relates to at least one of a user preference and a user capability.
